(19) United States
(12) Patent Application Publication
(10) Pub. No.: US 2022/0237905 A1
(43) Pub. Date: Jul. 28, 2022

(54) METHOD AND SYSTEM FOR TRAINING A MODEL FOR IMAGE GENERATION

(71) Applicants: TOYOTA MOTOR EUROPE, Brussels (BE); MAX-PLANCK-INSTITUT FÜR INFORMATIK, Saarbrücken (DE)

(72) Inventors: Daniel OLMEDA REINO, Brussels (BE); Apratim BHATTACHARYYA, Saarbrücken (DE); Mario FRITZ, Saarbrücken (DE); Bernt SCHIELE, Saarbrücken (DE)

(73) Assignees: TOYOTA MOTOR EUROPE, Brussels (BE); MAX-PLANCK-INSTITUT FÜR INFORMATIK, Saarbrücken (DE)

(21) Appl. No.: 17/610,004

(22) PCT Filed: May 28, 2019
(86) PCT No.: PCT/EP2019/063853

§ 371 Date: Nov. 9, 2021

(51) Int. Cl. G06V 10/82; G06V 10/778; G06V 10/774; G06N 3/04

(52) U.S. Cl. CPC G06V 10/82; G06N 3/0454; G06V 10/7747; G06V 10/7796

(57) ABSTRACT

A method and system for training a model for image generation. The model includes a hybrid variational auto-encoder (VAE)—generative adversarial network (GAN) framework. The method includes the steps of: multiple input of an input image into the VAE which outputs in response multiple distinct output image samples, determining the best of the multiple output image samples as a best-of-many sample, the best-of-many sample having the minimum reconstruction cost, and training the model based on a predefined training objective, the predefined training objective integrating the best-of-many sample reconstruction cost and a GAN-based synthetic likelihood term.

### FIELD OF THE DISCLOSURE

The present disclosure is related to the field of image processing, in particular to a method for training a model for image generation, the model comprising a hybrid variational auto-encoder (VAE)—generative adversarial network (GAN) framework.

### BACKGROUND OF THE DISCLOSURE

Generative Adversarial Networks (GANs) have achieved state-of-the-art performance, with respect to realism, in generative modeling of image distributions, cf.:

Ian J. Goodfellow, Jean Pouget-Abadie, Mehdi Mirza, Bing Xu, David Warde-Farley, Sherjil Ozairy, Aaron Courville, Yoshua Bengioz (2014) “Generative Adversarial Nets”, Advances in neural information processing systems, Pages 2672-2680.

GANs do not explicitly estimate the data likelihood. Instead, it aims to “fool” an adversary, so that the adversary is unable to distinguish between images from the true distribution and the generated images. This leads to the generation of very realistic images. However, there is no incentive to cover the whole data distribution. Entire modes of the true data distribution can be missed—commonly referred to as the mode collapse problem.

In contrast, auto-encoders explicitly maximize data log-likelihood and are forced to cover all modes. However, auto-encoder latent distributions are discontinuous and hard to estimate and thus do not allow for sampling. Variational Auto-encoders (VAEs) enable generation using auto-encoders by constraining the latent space to be Gaussian, cf.:

D. P. Kingma and M. Welling. Auto-encoding variational bayes. ICLR, 2014.

This allows for generation using the decoder by sampling through the latent space. However, the usual log-likelihood estimate using L₁ reconstruction cost leads to the generation of blurry images. Therefore, there has been a spur of recent work which aim to combine VAEs and GANs to jointly overcome each others shortcomings, cf. e.g.:

M. Rosca, B. Lakshminarayanan, D. Warde-Farley, and S. Mohamed. Variational approaches for auto-encoding generative adversarial networks. arXiv preprint arXiv:1706.04987, 2017.

Notably in this work, the VAE objective with the L₁ reconstruction likelihood is combined with a GAN discriminator based synthetic likelihood leading to image quality at par with plain GANs.

However, the reconstruction log-likelihood and the latent space constraint in the VAE objective are at odds, which makes it difficult to achieve both at the same time. This problem is further exacerbated with the addition of the synthetic likelihood in hybrid VAE-GANs. This forces the encoder to trade-off between the two and makes latent spaces drift from true Gaussian. This leads to the degradation in the quality and diversity of generated images at test time.

### SUMMARY OF THE DISCLOSURE

Currently, it remains desirable to enable an encoder to maintain both the latent representation constraint and high data log-likelihood and at the same time enhance the realism of generated images. In particular, it remains desirable to achieve high data log-likelihood and low divergence to the latent prior at the same time while generating realistic images.

Therefore, according to the embodiments of the present disclosure, a (desirably computer-implemented) method of training a model for image generation is provided. The model comprises (or is) a hybrid variational auto-encoder (VAE)—generative adversarial network (GAN) framework (i.e. architecture). The method comprises the steps of:

a—multiple input of an input image (i.e. of the same input image) into the VAE which outputs in response multiple distinct output image samples,
b—determine the best of the multiple output image samples as a best-of-many sample, the best-of-many sample having the minimum reconstruction cost, and
c—train the model based on a predefined training objective, the predefined training objective integrating the best-of-many sample reconstruction cost and a GAN-based synthetic likelihood term.

By providing such a method, a novel objective is proposed which integrates a “Best-of-Many” sample reconstruction cost and a synthetic likelihood term. This proposed objective enables the hybrid VAE-GAN framework to achieve high data log-likelihood and low divergence to the latent prior at the same time.

In other words, the constraints on the VAE can be relaxed, giving the encoder multiple chances to draw samples with high reconstruction likelihood—only the best sample being penalized so that it can achieve both good reconstructions and maintain a latent space close to Gaussian. Furthermore, a synthetic likelihood term can be integrated in the novel objective to yield a novel hybrid VAE-GAN framework. The GAN-based synthetic likelihood term integrated to the objective can enhance the realism of generated images.

The model may be trained by using only the best-of-many sample for training the model and by disregarding the further multiple output image samples.

The model may be trained based on the best-of-many sample in relation to the input image according to a predefined VAE objective.

The model may be a (or may comprise at least one) deep neural network.

In particular the model may comprise a variational auto-encoder (VAE) including a recognition network and a generator and a generative adversarial network (GAN) including a generator and a discriminator.

The variational auto-encoder (VAE) and the generative adversarial network (GAN) may share a common generator. Hence, the model is desirably “hybrid” in the sense that the VAE and the GAN share the same Generator G_{θ}.

The model may be trained in step c based on the GAN-based synthetic likelihood term to learn generating sharper images by leveraging a discriminator of the GAN which is jointly trained to distinguish between real and generated images.

During each training iteration the latent distribution of the input image may be sampled by multiple input of the input image into a recognition network which outputs in response respective regions in a latent space, and generation of respective output image samples in the image space by inputting the respective regions in the latent space into a generator.

The output image samples are inputted into a discriminator of the GAN which outputs the GAN-based synthetic likelihood term.

More in particular or as an alternative only the worst of the multiple output image samples may be inputted into a discriminator of the GAN which outputs the GAN-based synthetic likelihood term. With regard to the multiple output image samples, the term “worst” may mean the least realistic of the multiple output image samples.

The GAN-based synthetic likelihood term may have a Lipschitz constant. This Lipschitz constant may be constrained to be equal to a predetermined value, in particular equal to 1, using e.g. Spectral Normalization.

The present disclosure further relates to a (computer) system for training a model for image generation. The model comprises a hybrid variational auto-encoder (VAE)—generative adversarial network (GAN) framework. The system comprises:

a module A configured for a multiple input of an input image into the VAE which outputs in response multiple distinct output image samples, a module B for determining the best of the multiple output image samples as a best-of-many sample, the best-of-many sample having the minimum reconstruction cost, and
a module C for training the model based on a predefined training objective, the predefined training objective integrating the best-of-many sample reconstruction cost and a GAN-based synthetic likelihood term.

The system may comprise the model, i.e. a hybrid variational auto-encoder (VAE)—generative adversarial network (GAN) framework.

The system may comprise further (sub-) modules and features corresponding to the features of the method described above.

The present disclosure further relates to a (computer) system for generating an image sample, comprising the trained model of step c of the method described above or of the trained module D of the system described above.

Furthermore the present disclosure relates to a computer program including instructions for executing the steps of a method, as described above, when said program is executed by a computer.

This program can use any programming language and take the form of source code, object code or a code intermediate between source code and object code, such as a partially compiled form, or any other desirable form.

Finally, the present disclosure relates to a recording medium readable by a computer and having recorded thereon a computer program including instructions for executing the steps of a method, as described above.

The information medium can be any entity or device capable of storing the program. For example, the medium can include storage means such as a ROM, for example a CD ROM or a microelectronic circuit ROM, or magnetic storage means, for example a diskette (floppy disk) or a hard disk.

Alternatively, the information medium can be an integrated circuit in which the program is incorporated, the circuit being adapted to execute the method in question or to be used in its execution.

It is intended that combinations of the above-described elements and those within the specification may be made, except where otherwise contradictory.

It is to be understood that both the foregoing general description and the following detailed description are exemplary and explanatory only and are not restrictive of the disclosure, as claimed.

The accompanying drawings, which are incorporated in and constitute a part of this specification, illustrate embodiments of the disclosure and together with the description, and serve to explain the principles thereof.

### BRIEF DESCRIPTION OF THE DRAWINGS

FIG. 1 shows a schematic flow chart of the steps of a method for training a model for image generation according to embodiments of the present disclosure;

FIG. 2 shows a schematic block diagram of a system according to embodiments of the present disclosure; and

FIG. 3 shows a schematic block diagram of a hybrid VAE-GAN model according to embodiments of the present disclosure.

### DESCRIPTION OF THE EMBODIMENTS

Reference will now be made in detail to exemplary embodiments of the disclosure, examples of which are illustrated in the accompanying drawings. Wherever possible, the same reference numbers will be used throughout the drawings to refer to the same or like parts.

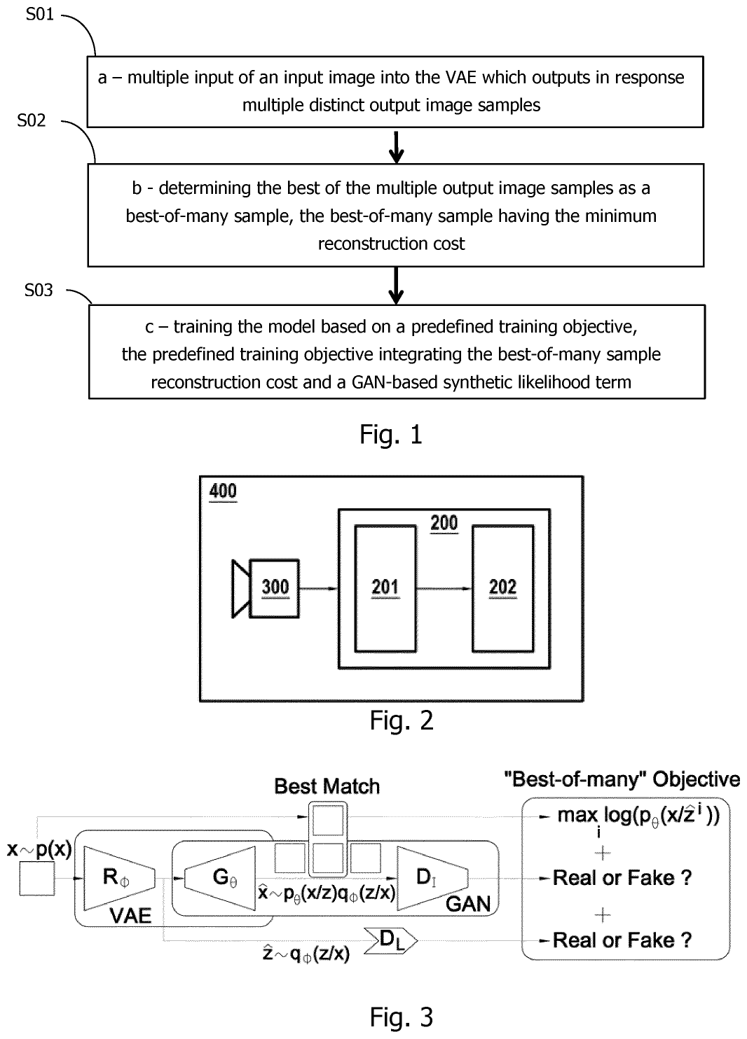

FIG. 1 shows a schematic flow chart of the steps of a method for training a model for image generation according to embodiments of the present disclosure. The model has a hybrid variational auto-encoder (VAE)—generative adversarial network (GAN) architecture.

The aim of the training method is to learn generative models for image distributions x˜p(x) that transform a latent distribution z˜p(z) to a learned distribution \hat{x}˜p_{θ}(x) approximating p(x). The samples from the learned distribution \hat{x}˜p_{θ}(x) must be sharp and realistic (likely under p(x)) and diverse—covering all modes of the distribution p(x).

In a first step S01 the same input image in inputted multiple times into the VAE which outputs in response respective multiple distinct output image samples. This allows the encoder multiple chances to draw desired samples.

In a subsequent step S02 the best of the multiple output image samples is determined. Said best output image is referred to in the following as a “best-of-many sample”. The best-of-many sample is characterized by having the minimum reconstruction cost compared to the other output samples.

In a further step S03 the model is trained based on a predefined training objective. Said predefined training objective integrates (or is based on or comprises) the best-of-many sample reconstruction cost and a GAN-based synthetic likelihood term.

Due to this objective the encoder is enabled to maintain low divergence to the prior while generating realistic images. Further desirable details of the training method are described in the following, also in context of FIG. 3.

FIG. 2 shows a schematic block diagram of a system according to embodiments of the present disclosure.

In this figure, a system 200 for training a model for image generation has been represented. The model comprises a hybrid variational auto-encoder (VAE)—generative adversarial network (GAN) framework. This system 200, which may be a computer, comprises a processor 201 and a non-volatile memory 202. The system 200 may not only be configured for training the model for image generation. It may also apply the trained model to another algorithm 400. For example the trained model may be applied to a computer vision system 400. In other words, a computer vision system for processing an input image sample 400 may comprise a pre-processor module configured to generate image samples based, the pre-processor module comprising said trained model.

As an option, the system 200 may further be connected to a (passive) optical sensor 300, in particular a digital camera. The digital camera 300 is configured such that it can take pictures which may be used as input image samples provided to the model.

In the non-volatile memory 202, a set of instructions is stored and this set of instructions comprises instructions to perform a method for training a model.

In particular, these instructions and the processor 201 may respectively form a plurality of modules:

a module A configured for a multiple input of an input image into the VAE which outputs in response multiple distinct output image samples,
a module B for determining the best of the multiple output image samples as a best-of-many sample, the best-of-many sample having the minimum reconstruction cost, and
a module C for training the model based on a predefined training objective, the predefined training objective integrating the best-of-many sample reconstruction cost and a GAN-based synthetic likelihood term.

FIG. 3 shows a schematic block diagram of a hybrid VAE-GAN model according to embodiments of the present disclosure. In particular, FIG. 3 shows the model architecture at training time. The model is “hybrid” such that the VAE and the GAN share the same Generator G_{θ}.

The model thus leverages the strengths of VAEs and GANs to attain the two goals set out above. The GAN portion (G_{θ},D_{I}) alone cangenerate realistic images, but has trouble covering all modes. The VAE portion (R_{ϕ},G_{θ},D_{L}) can cover all modes of the distribution p(x). However, this comes at a cost—it is difficult to maintain both the VAE latent space close to Gaussain and cover all modes of the distribution p(x) at the same time. Therefore, in contrast to previous hybrid VAE-GAN approaches (Rosca et. al. as cited above), a novel objective is employed which leverages “Best-of-Many” samples to cover all modes of the distribution p(x) while generating realistic images and maintaining a latent space as close to Gaussian as possible.

The following detailed description begins with an explanation of the VAE objective and its shortcomings, followed by the proposed “Best-of-Many” objective for image generation which address its shortcomings.

### Shortcomings of the VAE Objective

The VAE objective maximizes the log-likelihood of the data (x˜p(x)). The log-likelihood, assuming the latent space to be distributed according to p(z) is,

log(p_{θ}(x))=log(∫p_{θ}(x|z)p(z)dz) (1)

Here, p(z) is usually Gaussian and the log-likelihood p_{θ}(x|z) is usually the L₁/L₂ norm based reconstruction (e^{-λ∥x-\hat{x}∥n}). This requires the generator G_{θ} to generate samples that reconstruct every training example x for a likely z˜p(z). This ensures that the decoder θ covers all modes of the data distribution x˜p(x). In contrast, GANs never directly maximize the (reconstruction based) likelihood and there is no direct incentive to cover all modes.

However, the integral in (1) is intractable. Variational inference may use an (approximate) variational distribution q_{ϕ}(z|x), which is jointly learned using an encoder,

$$log ( {p}_{θ} ( x ) ) = log ( \int {p}_{θ} ( x \vert z ) \frac{p ( z )}{{q}_{ϕ} ( z \vert x )} {q}_{Φ} ( z \vert x ) d z ) . \qquad ( 2 )$$

During training, samples may be drawn instead from a recognition network q_{ϕ}(z|x)(R_{ϕ}) and the variational auto-encoder based objective may be maximized,

[symbol]

_{VAE}= [symbol] _{q}_{_{ϕ}}^{(z|x)}log(p_{θ}(x|z))−KL(p(z)|q_{θ}(z|x)) (3)

This objective has two important shortcomings. Firstly, this objective severly constrains the recognition network q_{ϕ}(z|x) (R_{ϕ}) as high data log-likelihood and low divergence to the prior are at odds. As the expected log-likelihood is considered, the recognition network has to always generate latent samples \hat{z} which are decoded by the generator close to x. Otherwise, the expected data log-likelihood would be low. Thus, the encoder is forced to trade-off between a good estimate of the data log-likelihood and the divergence to the true latent p(z) distribution, which causes the generated latent space (by the recognition network) to be far from a Gaussain. Secondly, it considers only a reconstruction-based log-likelihood which is known to lead to blurry image generations.

Next, it is described how multiple samples can be effectively leveraged from q_{ϕ}(z|x) to deal with the first shortcoming. Finally, a synthetic likelihood term is integrated to deal with blurriness.

### Leveraging Multiple Samples

An alternative variational approximation of (1) may be derived, which uses multiple samples to relax the constrains on the recognition network. For example, the Mean-value theorem of Integration may be used, in order to derive a unconditional version of the (conditional) multi-sample objective starting from (2) (full derivation in Suppmat),

[symbol]

_{MS}=log(∫p_{θ}(x|z)q_{ϕ}(z|x)dz)−KL(p(z)∥q_{ϕ}(z|x)) (4)

In comparision to the VAE objective (3), in (4) the likelihood is computed considering all the generated samples. The recognition network gets multiple chances to draw samples with high likelihood. This encourages diversity in the generated samples and the recognition network can provide a good estimate of the data log-likelihood while not diverging from the prior p(z)—without trade-off.

However, also a good estimate of the likelihood p_{θ}(x|z) is desirable. Considering only L₁ or L₂ reconstruction based likelihoods would lead to the generation of blurry images. Therefore, (and because of the intractability of (1)), GANs instead use an adversary that provides indirect information of the likelihood—classifier that is jointly trained to distinguish between generated samples and real data samples.

Next, it is described how it can be leveraged such a classifier to directly obtain synthetic estimates of the likelihood that lead to the generation of crisp images.

Integrating Synthetic Likelihoods with the “Best-of-Many” Samples

Synthetic estimates of the likelihood leads to the generation of sharper images by leveraging a classifier which is jointly trained to distinguish between real and generated images. A generated image which is indistinguishable from a real image is assigned higher likelihood. Starting from (4), a synthetic likelihood term (with weight 1−α) is integrated to both encourage the generator to generate realistic images and to cover all modes (L₁ reconstruction loss), thus meeting the initial two goals. First the likelihood term is converted to a likelihood ratio form which allows for synthetic estimates,

$$log ( \int {p}_{θ} ( x \vert z ) {q}_{ϕ} ( z \vert x ) d z ) - KL ( p ( z ) \vert \vert {q}_{ϕ} ( z \vert x ) ) = ( 1 - α ) log ( \int {p}_{θ} ( x \vert z ) {q}_{ϕ} ( z \vert x ) d z ) + αlog ( \int {p}_{θ} ( x \vert z ) {q}_{ϕ} ( z \vert x ) d z ) - KL ( p ( z ) \vert \vert {q}_{ϕ} ( z \vert x ) ) ∝ ( 1 - α ) log ( \int \frac{{p}_{θ} ( x \vert z )}{p ( x )} {q}_{ϕ} ( z \vert x ) d z ) + αlog ( \int {p}_{θ} ( x \vert z ) {q}_{ϕ} ( z \vert x ) d z ) - K L ( p ( z ) \vert \vert {q}_{ϕ} ( z \vert x ) ) . \qquad ( 5 )$$

Now the likelihood ratio p_{θ}(x|z)/p(x) can be estimated using a classifier. To do this, the auxiliary variable y is introduced where, y=1 denotes that the sample was generated and y=0 denotes that the sample is from the true distribution. Now (6) can be written as (using Bayes theorem),

$$( 1 - α ) log ( \int \frac{{p}_{θ} ( x \vert z , y = 1 )}{p ( x \vert y = 0 )} {q}_{ϕ} ( z \vert x ) d z ) + αlog ( \int {p}_{θ} ( x \vert z ) {q}_{ϕ} ( z \vert x ) d z ) - K L ( p ( z ) \vert \vert {q}_{ϕ} ( z \vert x ) ) . \\ = ( 1 - α ) log ( \int \frac{{p}_{θ} ( y = 1 \vert z , x )}{p ( y = 0 \vert x )} {q}_{ϕ} ( z \vert x ) d z ) + αlog ( \int {p}_{θ} ( x \vert z ) {q}_{ϕ} ( z \vert x ) d z ) - K L ( p ( z ) \vert \vert {q}_{ϕ} ( z \vert x ) ) = ( 1 - α ) log ( \int \frac{{p}_{θ} ( y = 1 \vert z , x )}{1 - p ( y = 1 \vert x )} {q}_{ϕ} ( z \vert x ) d z ) + αlog ( \int {p}_{θ} ( x \vert z ) {q}_{ϕ} ( z \vert x ) d z ) - K L ( p ( z ) \vert \vert {q}_{ϕ} ( z \vert x ) ) . \qquad ( 6 )$$

The probability p_{θ}(y=1|z,x) may be estimated using a classifier D_{I}(x) (image discriminator in FIG. 3) which is jointly trained, leading to a synthetic estimate of the likelihood ratio,

$${ℒ}_{MS - S} ∝ ( 1 - α ) log ( \int \frac{{D}_{I} ( x \vert z )}{1 - {D}_{I} ( x \vert z )} {q}_{ϕ} ( z \vert x ) dz ) + α log ( \int {p}_{θ} ( x \vert z ) {q}_{ϕ} ( z \vert x ) d z ) - K L ( p ( z ) \vert \vert {q}_{ϕ} ( z \vert x ) ) . \qquad ( 7 )$$

Note that the synthetic likelihood D_{I}(x) is usually estimated using a softmax layer and the likelihood p_{θ}(x|z) takes the form e^{-∥x-\hat{x}∥n} in (7). Both these log-sum-exps are numerically unstable. It can be dealt with the first log-sum-exp using the Jenson-Shannon inequality,

$$log ( \int \frac{{D}_{I} ( x \vert z )}{1 - {D}_{I} ( x \vert z )} {q}_{ϕ} ( z \vert x ) d z ) \geq {E}_{{q}_{ϕ} ( z \vert x )} log ( \frac{{D}_{I} ( x \vert z )}{1 - {D}_{I} ( x \vert z )} )$$

As stochastic gradient descent is performed, it can be dealt with the second log-sum-exp after stochastic (MC) sampling of the data points. The log-sum-exp can be well estimated using the max—the “Best-of-Many” samples,

$$log ( \frac{1}{T} {\sum }_{i = 1}^{i = T} {p}_{θ} ( x \vert {\hat{z}}^{i} ) ) \geq {max}_{i} log ( {p}_{θ} ( x \vert {\hat{z}}^{i} ) ) - log ( T )$$

The “Best-of-Many” samples objective takes the form (ignoring the constant log (T) term and λ≥(1−α)),

$${ℒ}_{B M S - S} = {λ𝔼}_{{q}_{ϕ} ( z \vert x )} log ( \frac{{D}_{I} ( x \vert z )}{1 - {D}_{I} ( x \vert z )} ) + α {max}_{i} log ( {p}_{θ} ( x \vert {\hat{z}}^{i} ) ) - p ( z ) {q}_{ϕ} ( z \vert x ) . \qquad ( 8 )$$

Furthermore, the generator G_{θ} may be penalized using only the least realistic sample, and the likelihood ratio be estimated directly using D_{I},

$${ℒ}_{B M S - S} = λ {min}_{i} log ( {D}_{I} ( x \vert {\hat{z}}^{i} ) ) + α {max}_{i} log ( {p}_{θ} ( x \vert {\hat{z}}^{i} ) ) - K L ( p ( z ) \vert \vert {q}_{ϕ} ( z \vert x ) ) . \qquad ( 9 )$$

To further ensure smoothness, the Lipschitz constant K of D_{I} may be directly controlled, by setting it to be equal to 1, using Spectral Normalization, T. Miyato, T. Kataoka, M. Koyama, and Y. Yoshida. Spectral normalization for generative adversarial networks. ICLR, 2018.

The synthetic likelihood ratio term is namely unstable during training—as it is the ratio of outputs of a classifier, any instability in the output of the classifier is magnified. Therefore it is proposed to directly estimate the ratio using a network with a controlled Lipschitz constant, which leads to significantly improved stability.

In contrast to prior work (e.g. Rosca et.al.), (8) provides multiple chances to the recognition network to generate samples likely under the reconstruction based likelihood. Furthermore, the synthetic likelihood term ensures that every generated sample is realistic.

Intuitively, this objective can be seen as a generalization of prior hybrid VAE-GAN based models. If it is set T=1 in (8) the exact objective used in the a-GAN model is recovered. Moreover, in e.g. Rosca et.al. for every sample x˜p(x), the recognition network is used to obtain the exact \hat{z} from latent space. In contrast, the objective (8) only requires the recognition network to only point to the appropriate region in the latent space.

Next, a detailed description of the optimization of the hybrid VAE-GAN model is provided using the “Best-of-Many” samples objective, which is called BMS-GAN.

### Optimization

As recent works (e.g. Rosca et.al.) have shown, point-wise minimization of the KL-divergence using its analytical form leads to degradation in generatated image quality. The KL-divergence term can also be recast in a likelihood ratio form (similar as (6)) allowing to leverage synthetic likelihoods using a classifier and minimize it globally instead of point-wise. The latent space discriminator D_{L} is used to enforce the KL-divergence constraint p(z)q_{ϕ}(z|x) in (8).

During optimization, samples from the true data distribution x˜p(x) are first sampled. For each x, the recognition network R_{ϕ}, gives a region of the latent space q_{ϕ}(z|x). It is assumed q_{ϕ}(z|x)= [symbol] (μ(x), σ(x)). The generator G_{θ} now generates samples in the data (image) space \hat{x}˜p_{θ}(x|z)q_{ϕ}(z|x) from that region of the latent space. These samples are then given as input to the data (image) discriminator D_{I}, which provides a synthetic estimate of the likelihood. The latent space discriminator D_{L} uses the latent samples \hat{z}˜q_{ϕ}(z|x) to provide a synthetic estimate of the divergence KL(p(z)∥q_{ϕ}(z|x)).

Based on the generated samples and synthetic likelihood estimates, it is now updated: 1. D_{I} and D_{L} using the standard GAN update rule (using true and generated samples x and \hat{x}, z and \hat{z}). 2. R_{ϕ} using synthetic likelihood estimates from D_{I}, D_{L} and the “Best-of-Many” reconstruction cost maxᵢ log (p_{θ}(x|\hat{z}ⁱ)). 3. G_{θ} using synthetic likelihood estimate from D_{I} and the “Best-of-Many” reconstruction cost.

Throughout the description, including the claims, the term “comprising a” should be understood as being synonymous with “comprising at least one” unless otherwise stated. In addition, any range set forth in the description, including the claims should be understood as including its end value(s) unless otherwise stated. Specific values for described elements should be understood to be within accepted manufacturing or industry tolerances known to one of skill in the art, and any use of the terms “substantially” and/or “approximately” and/or “generally” should be understood to mean falling within such accepted tolerances.

Although the present disclosure herein has been described with reference to particular embodiments, it is to be understood that these embodiments are merely illustrative of the principles and applications of the present disclosure.

It is intended that the specification and examples be considered as exemplary only, with a true scope of the disclosure being indicated by the following claims.

1.-15. (canceled)

16. A method of training a model for image generation,
the model comprising a hybrid variational auto-encoder (VAE)—generative adversarial network (GAN) framework,
the method comprising the steps of:
a—multiple input of an input image into the VAE which outputs in response multiple distinct output image samples,
b—determine the best of the multiple output image samples as a best-of-many sample, the best-of-many sample having the minimum reconstruction cost,
c—train the model based on a predefined training objective, the predefined training objective integrating the best-of-many sample reconstruction cost and a GAN-based synthetic likelihood term.

17. The method according to claim 16, wherein
the model is trained by using only the best-of-many sample for training the model and by disregarding the further multiple output image samples.

18. The method according to claim 16, wherein
the model is trained based on the best-of-many sample in relation to the input image according to a predefined VAE objective.

19. The method according to claim 16, wherein
the model is a deep neural network or comprises at least one deep neural network.

20. The method according to claim 16, wherein
the model comprises:
a variational auto-encoder (VAE) including a recognition network and a generator, and
a generative adversarial network (GAN) including a generator and a discriminator.

21. The method according to claim 20, wherein
the variational auto-encoder (VAE) and the generative adversarial network (GAN) share a common generator.

22. The method according to claim 16, wherein
the model is trained in step c based on the GAN-based synthetic likelihood term to learn generating sharper images by leveraging a discriminator of the GAN which is jointly trained to distinguish between real and generated images.

23. The method according to claim 22, wherein
during each training iteration the latent distribution of the input image is sampled by:
multiple input of the input image into a recognition network which outputs in response respective regions in a latent space, and
generation of respective output image samples in the image space by inputting the respective regions in the latent space into a generator.

24. The method according to claim 16, wherein
the output image samples are inputted into a discriminator of the GAN which outputs the GAN-based synthetic likelihood term.

25. The method according to claim 16, wherein
only the worst of the multiple output image samples is inputted into a discriminator of the GAN which outputs the GAN-based synthetic likelihood term.

26. The method according to claim 16, wherein
the Lipschitz constant of the GAN-based synthetic likelihood term is constrained to be equal to a predetermined value using Spectral Normalization.

27. The method according to claim 26, wherein the predetermined value is equal to 1.

28. A system for training a model for image generation,
the model comprising a hybrid variational auto-encoder (VAE)—generative adversarial network (GAN) framework, the system comprising:
a module A configured for a multiple input of an input image into the VAE which outputs in response multiple distinct output image samples,
a module B for determining the best of the multiple output image samples as a best-of-many sample, the best-of-many sample having the minimum reconstruction cost, and
a module C for training the model based on a predefined training objective, the predefined training objective integrating the best-of-many sample reconstruction cost and a GAN-based synthetic likelihood term.

29. The system according to claim 28, further comprising the model.

30. A system for generating an image sample,
comprising one of the trained model of step c of claim 16 and the trained module C of claim 16, wherein
the Lipschitz constant of the GAN-based synthetic likelihood term is constrained to be equal to a predetermined value using Spectral Normalization.

31. A computer program comprising instructions for executing the steps of the method according to claim 16, when the program is executed by a computer.

32. A recording medium readable by a computer and having recorded thereon a computer program including instructions for executing the steps of a method according to claim 16.
